(19) United States
(12) Patent Application Publication
(10) Pub. No.: US 2025/0045060 A1
(43) Pub. Date: Feb. 6, 2025

(54) ADAPTIVE DEPLOYMENT RESTART FOR CONFIGURATION UPDATES

(71) Applicant: International Business Machines Corporation, Armonk, NY (US)

(72) Inventors: Thomas Soal, Hook (GB); Doina Lilliana Klinger, Winchester (GB); Barry Dow, Gosport Hamphshire (GB); Paul S. M Thorpe, Winchester (GB)

(73) Assignee: International Business Machines Corporation, Armonk, NY (US)

(21) Appl. No.: 18/230,428

(22) Filed: Aug. 4, 2023

(51) Int. Cl. G06F 9/4401

(52) U.S. Cl. CPC G06F 9/4403

(57) ABSTRACT

An embodiment identifies, by a deployment restart engine, a change in a configuration from a first version to a second version. The embodiment determines, by the deployment restart engine, based on the change, whether to restart a deployment associated with the configuration. The embodiment determines, by the deployment restart engine, a deployment dependency associated with the deployment. The embodiment restarts, by the deployment restart engine, responsive to a determination to restart the deployment, based on the deployment dependency, the deployment.

### BACKGROUND

The present invention relates generally to configuration updates. More particularly, the present invention relates to a method, system, and computer program for adaptive deployment restart for configuration updates.

In the field of software development and operations, a deployment may involve the process of making a software system or application available for use. This process may involve installing, configuring, testing, and running the system in a specific environment, such as a server or a cloud platform. Deployments can include various components such as the software application itself, databases, application programming interfaces (APIs), or any other services that the application needs to function. These components often need to interact with each other, forming a network of dependencies that all need to function together for the system to work as intended. A configuration in a software deployment may involve a set of parameters and settings that dictate how a particular component or the entire system operates. This could include anything from environmental variables that specify the system's runtime environment, to database connection details, to parameters that control how much system resources a component can use. Changes to these configurations can alter the behavior of a deployment. For instance, a change in the database configuration might necessitate a restart of both the database and any components that rely on it. Thus, managing configurations and understanding their impact on the overall system is a critical aspect of software deployment.

### SUMMARY

The illustrative embodiments provide for adaptive deployment restart for configuration updates. An embodiment includes identifying, by a deployment restart engine, a change in a configuration from a first version to a second version. The embodiment also includes determining, by the deployment restart engine, based on the change, whether to restart a deployment associated with the configuration. The embodiment also includes determining, by the deployment restart engine, a deployment dependency associated with the deployment. The embodiment also includes restarting, by the deployment restart engine, responsive to a determination to restart the deployment, based on the deployment dependency, the deployment.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment.

FIG. 2 depicts a block diagram of an example software integration process in accordance with an illustrative embodiment.

FIG. 3 depicts a block diagram of an example deployment environment in accordance with an illustrative embodiment.

FIG. 4 depicts a block diagram of an example process for adaptive deployment restart for configuration updates in accordance with an illustrative embodiment.

FIG. 5 depicts a block diagram of an example process for determining whether to restart a deployment in accordance with an illustrative embodiment.

FIG. 6 depicts a block diagram of an example process for restarting a deployment based on a deployment dependency in accordance with an illustrative embodiment.

FIG. 7 depicts a block diagram of an example process for adaptive deployment restart for configuration updates in accordance with an illustrative embodiment.

### DETAILED DESCRIPTION

In the realm of software development and information technology operations, a deployment may involve the process by which a software system or application is made available for use. This process may involve a series of steps such as installing the software, setting it up, conducting tests to ensure it operates as expected, and finally running it in a certain environment. This environment could be anything ranging from a specific server in a data center to a broader platform, such as a cloud-based environment. For example, consider an e-commerce business process integration flow that includes deployments such as the e-commerce platform itself, a customer relationship management system, an inventory management system, a payment processing service, and an email notification service. Each of these components may be separate deployments configured to function together to create the entire business process. Deployments are often multifaceted, involving various individual components that constitute the complete system. These components could include the main software application itself, ancillary services like databases or application programming interfaces (APIs), and other resources that the primary application may rely on to function correctly. Each of these components has a specific role to play and often needs to communicate and interact with other parts of the deployment to deliver the expected functionality.

In a software deployment scenario, a configuration may involve specific parameters and settings that influence how a system or a specific component within the system operates. These parameters can be diverse. For instance, they may include environmental variables that detail the conditions for the system's runtime environment, settings that govern the details of database connections, or specifications that control the system resources available to a certain component. For example, in the context of the above e-commerce business process integration flow, the configuration of the payment processing service might include parameters such as the payment gateway details, security protocols, and transaction handling rules. Similarly, the email notification service configuration may define the email server settings, email formats, and triggering conditions for different types of notifications.

However, the dynamic nature of these systems can pose challenges. Changes in a configuration can inadvertently affect multiple deployments that reference it, triggering a system-wide restart. This could be considered acceptable if the changes are necessary and benign, like in the case of a secured credential rotation. On the other hand, it can lead to significant disruptions if the changes are incompatible or erroneous. Operational services might prematurely inherit harmful changes and start failing, which can negatively affect the overall system performance and stability.

Existing workarounds often come with their own sets of challenges, such as additional management overheads and potential inefficiencies in operation. In some scenarios, these workarounds might be inadequate due to inherent limitations. As such, managing configuration changes in a more intelligent and efficient way becomes a pivotal requirement in maintaining the optimal functionality of these deployments.

The present disclosure addresses the deficiencies described above by providing a process (as well as a system, method, machine-readable medium, etc.) that intelligently manages configuration changes in deployments to prevent unnecessary disruption or failure of services. This process may involve a nuanced understanding of the dependencies of configurations, their impact on various deployments, and/or an optimized restart mechanism to apply necessary changes without causing avoidable restarts or service disruptions.

The illustrative embodiments provide for adaptive deployment restart for configuration updates. A “deployment,” as used herein, may refer to the process through which applications are made operational on specific infrastructures. For instance, in a cloud computing environment, a deployment might involve the orchestration of numerous services, including computational resources, storage services, and network configurations, to facilitate the operation of an application. A “deployment restart,” as used herein, may refer to the stopping and re-initiating of these orchestrated services, such as when updates or changes are made to the application or its supporting services. A “configuration,” as used herein, may refer to an element that holds parameters and settings for a deployment to function appropriately. These parameters might encompass system-specific settings, access protocols, or operational policies, among others. A “configuration update,” as used herein, may refer to a modification to one or more configuration parameters, potentially impacting the operation of the deployment.

Illustrative embodiments provide for identifying a change in a configuration from a first version to a second version. A version of a configuration may refer to a unique state of the configuration at a specific point in time. This state may encapsulate the parameters of the configuration and their respective values that dictate the behavior and operation of the deployment at that point in time. For instance, a first version of a configuration may include one set of credentials for connecting with a third-party application, such as an external payment processing service in the context of our e-commerce business process. If a second version of the configuration switches to a different, rotated set of credentials for the same third-party application, the system may identify this as a change that could potentially impact the functioning of the deployment.

Identifying a change in a configuration may involve comparing two versions of a configuration, which may involve techniques such as difference analysis that can highlight the variations between the two configuration states. It could also involve the use of software tools designed to conduct such comparisons and/or may involve manual review.

Illustrative embodiments provide for determining whether to restart a deployment associated with the configuration. Determining whether to restart a deployment associated with the configuration may involve evaluating changes in a system's configuration, analyzing their potential impact on the system, and/or deciding whether a system restart is necessary to incorporate those changes. For example, in a web application deployment, if a configuration change alters the connection parameters to a database, the system might need to be restarted to successfully incorporate these changes. This process could involve checks on the nature and magnitude of the configuration change, and its potential impacts on system functionality, performance, and security.

In some embodiments, determining whether to restart a deployment based on a change may comprise determining whether the change is a breaking change that disrupts existing functionality of the deployment. A “breaking change,” as used herein, may refer to a modification that, when implemented, impairs or discontinues the functionality of the existing deployment. For example, changing an API endpoint in a configuration could lead to failure of dependent services if they are not updated accordingly, thus constituting a breaking change. The system may be configured to forego restarting a deployment if a breaking change is identified, so as to prevent system failures.

In contrast to a breaking change, a “safe change,” may refer to a configuration modification that does not disrupt the existing functionality of a deployment. For example, a change in logging level from “INFO” to “DEBUG” may be considered a safe change, as it may not impact the core functions of the deployment. The system may be configured to restart the deployment if a safe change is identified, as it should result in no system failures.

In some embodiments, determining whether to restart the deployment based on the change may comprise determining whether the second version contains the first version. This process may involve checking if the modified configuration (the second version) includes all the elements of the previous configuration (the first version). For instance, if a second version adds a new component but still contains all components of the first version, a restart may not be necessary if the system is designed to dynamically accommodate such additions.

In some embodiments, determining whether to restart the deployment based on the change may comprise determining whether a deleted portion of the first version affects the deployment dependency. This process may involve checking if the removed parts from the first version had any operational implications on the dependent components of the deployment. For instance, if a removed part had a role in communication between components, then the system might need to restart to ensure the dependent components can adapt to this change.

In some embodiments, determining whether to restart the deployment based on the change may comprise determining whether the deployment dependency is scaled to zero. A dependency “scaled to zero” may represent a component or service in a system that is not in use or has been scaled down to have no active instances. This could be due to reasons such as cost-saving during low-traffic periods or it being a deprecated service. If a change only impacts such a dependency, it might not warrant a system restart. Determining whether the deployment dependency is scaled to zero may involve checking the current status of all dependencies linked to a configuration. This process could involve monitoring the deployment state or querying a service registry that keeps track of service instances.

In some embodiments, determining whether to restart the deployment based on the change may comprise determining whether a configuration type of the configuration is required by the deployment dependency. A “configuration type,” as used herein, may refer to the nature or category of the configuration such as system configurations, application configurations, or network configurations. For example, if a change is made to an application configuration like user interface (UI) settings, and the configuration type analysis reveals that it does not affect the system or network configurations, a restart might not be necessary. Determining whether a configuration type of the configuration is required by the deployment dependency may involve identifying if the components dependent on the configuration need a specific type of configuration for their operation. For instance, if the configuration change pertains to a logging service which is not needed for the dependent components, it may not necessitate a restart.

In some embodiments, determining whether to restart the deployment based on the change may comprise determining whether an addition of the second version is related to an external system. An “external system,” as used herein, may refer to a system that operates outside the deployment but interacts with it. For example, a third-party API or a remote database server may be examples of external system. If a configuration change involves adding an interaction with a new external system, a restart might be needed for the deployment to establish a connection with the new system. Conversely, if a configuration change only involves internal systems, a restart may not be warranted. Determining whether an addition of the second version is related to an external system may involve examining the nature of the additions in the second version and their relationships with systems outside the deployment. For instance, if the change includes new parameters for an external API, the deployment may need to restart to initialize the connection with the updated parameters.

In some embodiments, determining whether to restart the deployment based on the change may involve analyzing other aspects of the deployment, considering factors such as the type and nature of the change, the dependencies affected, and the potential impact on system operations, among others. It is to be understood that the scenarios provided herein are illustrative only and are not intended to be exhaustive.

Illustrative embodiments provide for determining a deployment dependency associated with a deployment. A “deployment dependency,” as used herein, may refer to other software components or services that a particular deployment relies on for its operation. For example, a web application might depend on a database service for storing and retrieving data. Understanding these dependencies may be used to decide whether to restart a deployment.

Determining a deployment dependency associated with the deployment may involve identifying the interconnections between different components or services in the system. This could be done by analyzing the system's configuration files, service registry, or other forms of dependency mappings. The goal may be to create a comprehensive map of dependencies that can be used to determine the ripple effects of configuration changes.

For example, in some embodiments, determining a deployment dependency may involve determining whether the deployment depends on a second deployment. Understanding these cross-deployment dependencies may be used to predicting the cascading impacts of changes and avoiding service disruption.

Illustrative embodiments provide for restarting the deployment. Restarting a deployment may involve halting the current running instances of a deployment and starting new instances with the updated configuration. This process could involve draining traffic from the old instances, terminating them, and then launching new instances. In some other embodiments, for instance, restarting a deployment may be based on a deployment dependency. If a change affects a service that a deployment is dependent upon, a restart may be necessary even if the change itself does not directly affect the deployment.

For example, in some embodiments, restarting the deployment based on the deployment dependency may include restarting the deployment responsive to a determination that the deployment does not depend on a second deployment. If the deployment is independent, for instance, the system may restart that independent deployment first. On the other hand, if the deployment depends on one or more other deployments or other dependencies, the deployment may be skipped until those dependencies are restarted. This process may help avoid a cascading series of failures, should any arise.

The second deployment may be restarted based on the second deployment dependency. The second deployment may be restarted first, for instance, if the second deployment is independent. For example, if a web application depends on a database service and the database service has undergone a significant configuration change, the database service and potentially the web application may both need to be restarted to ensure continued compatibility and functionality. In this scenario, the system may first restart the database service before restarting the web application, since the web application depends on the former.

Illustrative embodiments provide for determining a plurality of deployment dependencies associated with a configuration, and determining a restart order for the plurality of deployment dependencies. Determining a plurality of deployment dependencies associated with the configuration may involve identifying multiple interdependent services associated with the configuration (e.g., within a deployment), where each of these services may need to be considered when deciding on system restarts. Determining a restart order for the plurality of deployment dependencies may involve designing a sequence in which services are restarted to ensure minimum disruption to system operations. This could involve restarting services with fewer dependencies first, and gradually moving up the dependency chain to more interdependent services.

In some embodiments, the restart order may begin with an independent deployment dependency. An “independent deployment dependency,” as used herein, may refer to a component or service that does not rely on any other components or services for its operation. These components can be restarted first, as their operation may not influence or depend on the operation of others. Illustrative embodiments provide for selecting a restart technique responsive to a determination to restart the deployment. A “restart technique,” as used herein, may refer to the method or strategy employed to restart a software deployment after a change has been made, such as a configuration update. The technique chosen may be influenced by the nature of the change, the structure of the deployment, and/or the need to minimize downtime and disruption to users.

For example, in some embodiments, the restart technique may include a rolling restart and/or a blue-green restart. These two strategies may balance the need to incorporate configuration changes with the goal of minimizing service disruptions. A “rolling restart,” as used herein, may refer to the process of restarting components or services one after the other or in small groups, to ensure that the system remains partially operational throughout the restart process. For example, in a cluster of servers, one could restart a single server at a time, ensuring the remaining servers can still handle user requests. A “blue-green restart,” as used herein, may refer to the process of setting up an entirely new (green) environment parallel to the current (blue) one, implementing changes in the green environment, and then gradually shifting traffic from blue to green. Once all traffic has been moved, the blue environment can be shut down. This approach can potentially eliminate any downtime associated with the restart process.

Illustrative embodiments provide for determining if a restart would cause a failure. A “failure,” as used herein, may refer to an incorrect operation of a system or process, which may cause disruption to the deployment's normal functioning. A failure could manifest in various ways, such as service disruption, data loss, incorrect processing of data, or inability to handle user requests. These failures could stem from several factors like hardware issues, software bugs, security vulnerabilities, or inappropriate handling of configuration changes.

Determining if a restart would cause a failure may involve one or more checks and validations. The system could first assess the compatibility of the updated configuration with the current deployment environment. It may employ a variety of testing strategies like regression tests to ensure that the updated configurations do not break existing functionality. The system could also use validation mechanisms to verify the configuration values, ensuring they conform to the expected formats and standards. Additionally, the system may also analyze the dependencies and interconnections of the configurations to predict and prevent potential cascading failures that could arise from a restart. For instance, if a database service, which is a dependency for a certain deployment, has its access credentials changed without updating the dependent deployment, a restart could result in the deployment failing to reconnect to the database service.

Illustrative embodiments provide for the assessment of deployment status. A “deployment status,” as used herein may refer to various states of the deployment such as running, paused, stopped, or being scaled up or down. Assessing the status could involve using system metrics, status reports from deployment management tools, direct inspection of the deployment's operational state, or any other suitable information. Assessing a deployment status may involve relying on internal monitoring tools and/or external metrics to determine the status. These could include analyzing logs, server health checks, or utilizing container orchestration tools like Kubernetes, which can provide real-time status reports about running pods. For instance, the system may use these tools and metrics to assess whether the deployment is currently running and/or scaled up. This can help ensure the seamless operation of the deployment and inform decision-making processes about potential restarts.

Illustrative embodiments provide for user-initiated restarts following configuration updates. A “user-initiated restart,” as used herein, may refer to a manual restart triggered by a user or system administrator. For example, a user might initiate a restart via a command-line interface or a deployment management tool's user interface. A user-initiated restart may involve several steps depending on the deployment environment and the tools being used. For instance, in a containerized deployment, the user could use Kubernetes commands to manually restart specific pods. In a more traditional environment, this might involve connecting to the server and restarting the service manually using system commands. The feature of user-initiated restart may allow the system to proceed without being hindered by an automated restart mechanism, thereby giving the user more control over their deployment.

Illustrative embodiments provide for user notification regarding a restart. The system might leverage various communication channels to deliver these notifications, such as emails, text messages, or in-app notifications. These alerts may inform the user about potential impacts of the restart, ensuring that they are aware of the changes and can make informed decisions about their deployments. For instance, a user notification may alert a user that a restart may result in the incorporation of any modifications to configurations their deployments are dependent on. These user notifications may be transmitted via e-mail, mobile phone, or through a dedicated application, among others, depending on the particular use.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

The process software for adaptive deployment restart for configuration updates is integrated into a client, server and network environment, by providing for the process software to coexist with applications, operating systems and network operating systems software and then installing the process software on the clients and servers in the environment where the process software will function.

The integration process identifies any software on the clients and servers, including the network operating system where the process software will be deployed, that are required by the process software or that work in conjunction with the process software. This includes software in the network operating system that enhances a basic operating system by adding networking features. The software applications and version numbers will be identified and compared to the list of software applications and version numbers that have been tested to work with the process software. Those software applications that are missing or that do not match the correct version will be updated with those having the correct version numbers. Program instructions that pass parameters from the process software to the software applications will be checked to ensure the parameter lists match the parameter lists required by the process software. Conversely, parameters passed by the software applications to the process software will be checked to ensure the parameters match the parameters required by the process software. The client and server operating systems, including the network operating systems, will be identified and compared to the list of operating systems, version numbers and network software that have been tested to work with the process software. Those operating systems, version numbers and network software that do not match the list of tested operating systems and version numbers will be updated on the clients and servers in order to reach the required level.

After ensuring that the software, where the process software is to be deployed, is at the correct version level that has been tested to work with the process software, the integration is completed by installing the process software on the clients and servers.

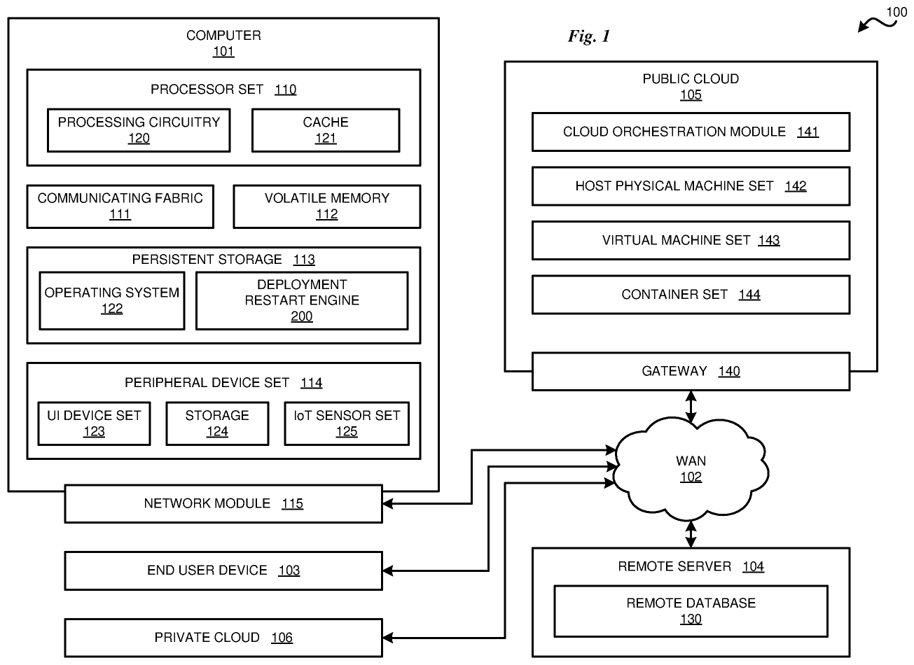

With reference to FIG. 1, this figure depicts a block diagram of a computing environment 100. Computing environment 100 contains an example of an environment for the execution of at least some of the computer code involved in performing the inventive methods, such as deployment restart engine 200 for adaptive deployment restart for configuration updates. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

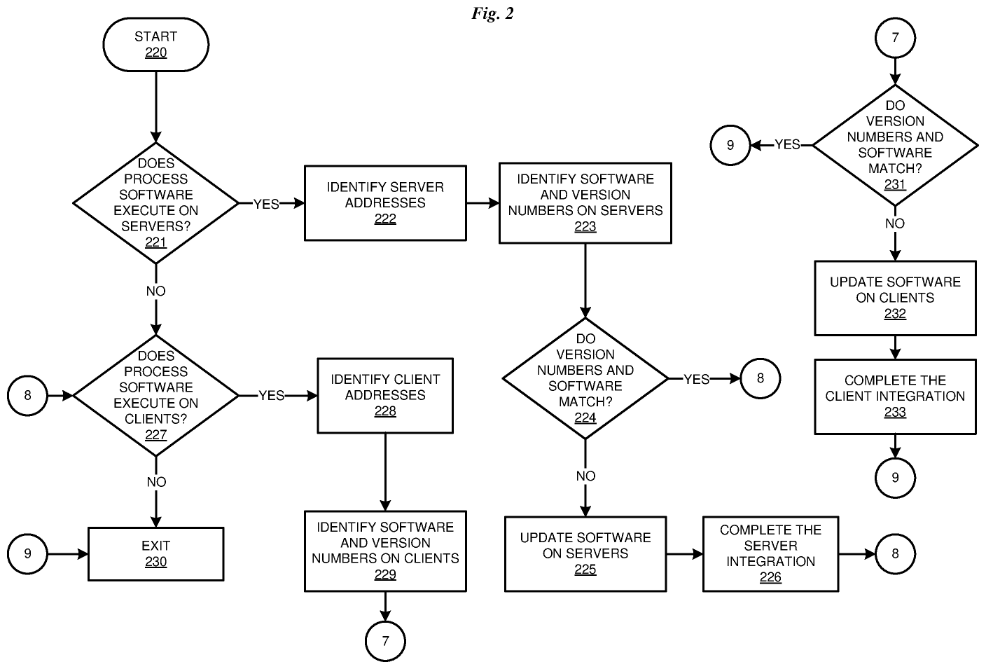

With reference to FIG. 2, this figure depicts a block diagram of an example software integration process, which various illustrative embodiments may implement. Step 220 begins the integration of the process software. An initial step is to determine if there are any process software programs that will execute on a server or servers (221). If this is not the case, then integration proceeds to 227. If this is the case, then the server addresses are identified (222). The servers are checked to see if they contain software that includes the operating system (OS), applications, and network operating systems (NOS), together with their version numbers that have been tested with the process software (223). The servers are also checked to determine if there is any missing software that is required by the process software (223).

A determination is made if the version numbers match the version numbers of OS, applications, and NOS that have been tested with the process software (224). If all of the versions match and there is no missing required software, the integration continues (227).

If one or more of the version numbers do not match, then the unmatched versions are updated on the server or servers with the correct versions (225). Additionally, if there is missing required software, then it is updated on the server or servers (225). The server integration is completed by installing the process software (226).

Step 227 (which follows 221, 224 or 226) determines if there are any programs of the process software that will execute on the clients. If no process software programs execute on the clients, the integration proceeds to 230 and exits. If this not the case, then the client addresses are identified (228).

The clients are checked to see if they contain software that includes the operating system (OS), applications, and network operating systems (NOS), together with their version numbers that have been tested with the process software (229). The clients are also checked to determine if there is any missing software that is required by the process software (229).

A determination is made if the version numbers match the version numbers of OS, applications, and NOS that have been tested with the process software (231). If all of the versions match and there is no missing required software, then the integration proceeds to 230 and exits.

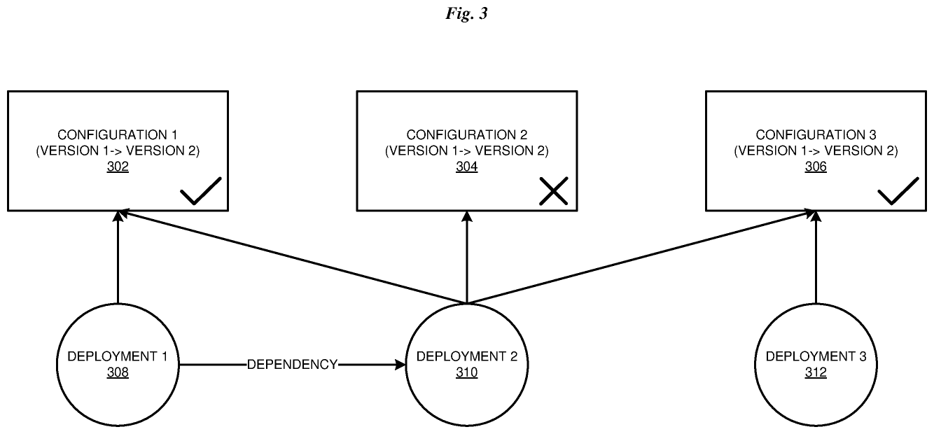

With reference to FIG. 3, this figure depicts a block diagram of an example deployment environment 300. It is to be understood that the deployment environment 300 may comprise additional or fewer components than those shown in the illustrative embodiment.

In the depicted example, deployment environment 300 may comprise configurations 302, 304, and 306, and deployments 308, 310, and 312. These elements may collectively determine the operation and functionality of the deployment environment, allowing for the coordinated execution of processes and services.

Configurations 302, 304, and 306 may represent different setups or operational parameters for various aspects of the deployment environment. For instance, configuration 302 could specify the details of a database connection setup, such as connection strings, security credentials, and the database schema. Configuration 304 might delineate an API gateway setup, including endpoint definitions, throttling limits, and security settings. Configuration 306, on the other hand, could encapsulate a server setup, including server parameters, resource limits, and load balancing rules.

Deployments 308, 310, and 312 may represent the operational components of the deployment environment, each offering specific functionalities. For instance, deployment 308 might be a web application service, hosting the user interface and processing user requests. Deployment 310 could represent a database service, managing data storage and retrieval based on requests from other services like the web application service. Deployment 312 might represent an authentication service, handling user authentication and authorizing user access based on security policies.

Each of these deployments may be dependent on one or more configurations for its operation. For example, the web application service (deployment 308) may rely on the database connection setup (configuration 302) and on another deployment (deployment 310). The database service (deployment 310) may be dependent on configurations 302, 304, and 306. Furthermore, the authentication service (deployment 312) may depend on the server setup (configuration 306). Any modifications in these configurations might require a restart in the corresponding deployment.

As illustrated, a deployment could be dependent on another deployment, depicted by the dependency arrow between deployment 308 and 310. This could mean, for example, that the web application service (deployment 308) relies on the database service (deployment 310) for data access.

Upon modification of the configurations, a restart might be initiated. For example, if configuration 302 (version 1) is updated to a new version (version 2), the system may check if the dependent deployments 308 and 310 are affected by this change. If version 2 introduces non-breaking changes and removes parts needed by deployments 308 and 310, a restart may be initiated. However, if version 2 merely extends version 1 without removing any crucial parts, and if the deployments are not reliant on the added features, a restart may not be initiated. If a restart is deemed necessary, the system may follow a predetermined order, such as first restarting independent deployments or those with fewer dependencies, before proceeding to restart the more interconnected ones.

For instance, in the given scenario, configuration 302 may represent a safe change. The safe change may represent updates or modifications to a configuration that do not interrupt the operation or functionality of any dependent deployments. When a safe change occurs in configuration 302, it may imply that there is no destructive alteration that could disrupt the deployment's operations. In response to this safe change, the system may initiate a restart sequence to apply the updated configuration. Beginning with deployment 310, the system may restart this deployment first as it is an independent deployment, unlike deployment 308 which depends on deployment 310, to avoid a cascading series of failures should any arise. Once the successful application of the updated configuration and stabilization of deployment 310 is confirmed, the system may proceed to restart deployment 308. The latter might also be dependent on configuration 302 or on deployment 310, which in turn relies on the updated configuration. The restart sequence may ensure minimal disruption and guarantee that each deployment operates with the most recent, compatible configuration.

In contrast, configuration 304 might represent a breaking change. The breaking change may represent modifications in a configuration that can disrupt or impair the operation of dependent deployments because of removed or altered elements. When a breaking change is detected in configuration 304, the system may respond cautiously to prevent potential system failures or inconsistencies. As the modification could potentially impair dependent deployments' operations, the system may refrain from initiating a restart sequence. Instead, alternative procedures like alerting the operations team or triggering automated mitigation processes might be undertaken.

Finally, configuration 306 might represent another safe change. In this case, the safe change may introduce new aspects that the deployments require. For example, it could be an enhancement or optimization that affects the current functionality or operation of any deployment. When such a change occurs in configuration 306, the system may recognize that the dependent deployments can be restarted without any loss in functionality or performance. Therefore, in such instances, a restart of deployment 310 and/or deployment 312 may be initiated in either order, leading to efficient resource utilization and minimized downtime in the deployment environment.

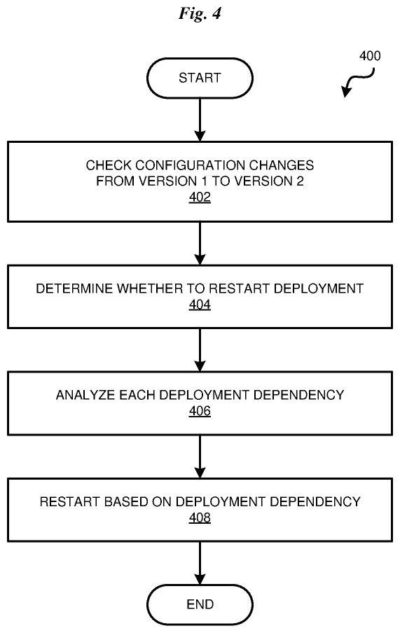

With reference to FIG. 4, this figure depicts a block diagram of an example process for adaptive deployment restart for configuration updates in accordance with an illustrative embodiment 400. The example block diagram of FIG. 4 may be implemented using deployment restart engine 200 of FIG. 1.

In the illustrative embodiment, at block 402, the process may check configuration changes from version 1 to version 2. This step may involve analyzing the updated configuration's structure, analyzing aspects from high-level architectural changes to alterations in individual parameters. For example, it could assess changes such as the addition of a new database, modification of an API endpoint, or changes in environmental variables.

At block 404, the process may determine whether a restart should be initiated. This step may involve determining whether a restart is necessary given the changes detected in block 402. For instance, the process may utilize algorithms to identify safe changes that can be accompanied by a restart, or breaking changes that could disrupt system operations if accompanied by a restart.

A breaking change in a configuration can be detected using a variety of methods, including static and dynamic analysis techniques. For instance, one method might involve comparing the new configuration version with the previous version. This comparison could be performed on a granular level, examining each element or parameter for alterations. If a key element or parameter has been removed or significantly altered in a way that affects the operation of dependent deployments, this might indicate a breaking change. Additionally, validation checks against the application's requirements or the system's operational parameters could also be utilized. These checks might involve simulated or actual execution of the deployments with the new configuration to detect potential runtime errors or performance degradation.

On the other hand, the detection of a safe change in a configuration might involve similar comparison and validation techniques but with a focus on ensuring the continuity and stability of system operations. A safe change may be characterized by additions or alterations that do not remove or significantly alter existing elements or parameters required by the dependent deployments. To confirm a change as safe, the system might compare the updated configuration with the previous version, checking that all elements and parameters crucial to the dependent deployments remain intact. Additionally, the system could validate that the updated configuration meets all the necessary criteria for maintaining system performance and stability. This process might involve running tests or simulations to ensure the change does not introduce any new errors or performance issues.

At block 406, the process may analyze each deployment dependency. This analysis could involve creating a dependency graph or matrix that maps out which deployments depend on the updated configurations and on other deployments. This step might be accomplished by querying metadata associated with each deployment or by analyzing the deployments' configuration usage patterns. It may be needed to identify not only which deployments rely directly on the modified configurations, but also those which indirectly depend on them through their dependency on other deployments.

At block 408, the process may restart based on deployment dependency. This step may entail utilizing selecting restart techniques such as rolling restarts or blue-green deployments to ensure service continuity while updating the deployments. For instance, if deployment A and B both rely on a changed configuration, but B also depends on A, the system may first restart A followed by B to ensure integrity and avoid possible cascading failures. It is to be understood that steps may be skipped, modified, or repeated in the illustrative embodiment. Moreover, the order of the blocks shown is not intended to require the blocks to be performed in the order shown, or any particular order.

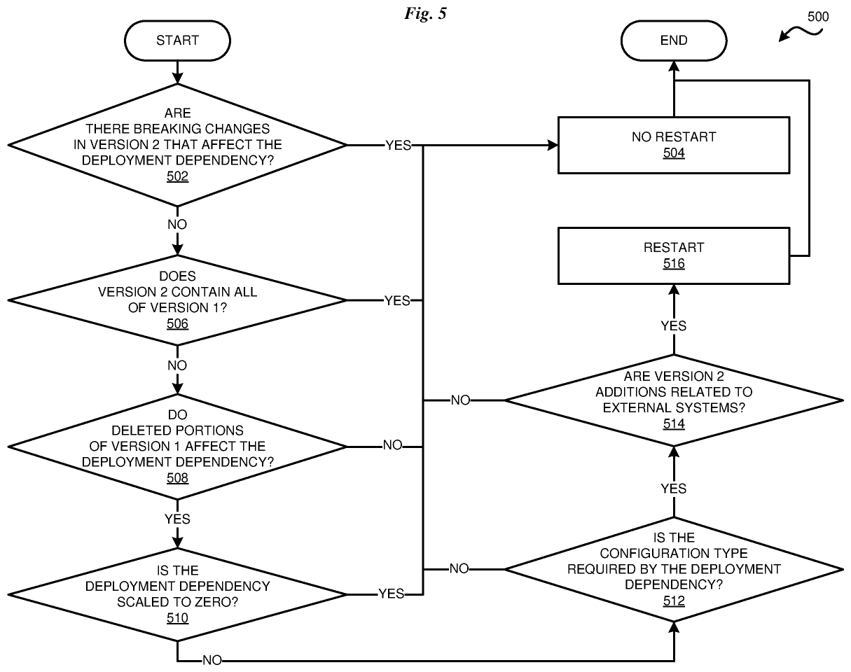

With reference to FIG. 5, this figure depicts a block diagram of an example process for determining whether to restart a deployment in accordance with an illustrative embodiment 500. The example block diagram of FIG. 4 may be implemented using deployment restart engine 200 of FIG. 1.

In the illustrative embodiment, at block 502, the process may determine whether there are breaking changes in version 2 that affect the deployment dependency. A breaking change may be a modification that disrupts the existing functionality or behavior of the deployment. This could be a modification in a database connection string, an update in a vital software library, or a change in the endpoints of an API that the deployment depends upon.

If such breaking changes are identified, the process may progress to block 504, where the process may determine not to restart the deployment due to a potential breakage. For example, if a critical library that the deployment relies on has been updated and is not backward compatible, the system at block 504 may avoid triggering a restart to prevent disruptions or failures.

At block 506, the process may determine whether version 2 contains all of version 1. In some embodiments, the determination may be confined to the contents of version 1 needed by the deployment dependency. At this step, the process may verify the compatibility of the new version with the current deployment. If version 2 retains all the necessary aspects of version 1, the process, at block 504, may establish that no restart is necessary. This scenario may indicate that the current deployment can continue to function properly with the existing components.

At block 508, if version 2 does not contain all of version 1, the process may determine whether the deleted portions of version 1 affect the deployment dependency. If version 2 does delete only elements of version 1 that are not crucial to the deployment's operation (because they are unused or redundant, for instance), the process at block 504 may determine that no restart should be initiated.

At block 510, the process may determine whether the deployment dependency is scaled to zero. This situation may represent a case where the deployment dependency has zero replicas running, essentially rendering it to an inactive state. If the deployment is inactive, there may be no need for a restart regardless of any configuration changes, leading the process to block 504.

At block 512, the process may determine whether the configuration type is required by the deployment dependency. This evaluation may be based on the specific configuration or file format associated with each deployment. For instance, consider two configuration types: “serverconf.yaml” and “accounts.yaml.” In the case of serverconf.yaml, it may not be bundled directly with the deployment, instead, it is fetched dynamically from a file or another deployment at runtime. This approach offers flexibility, as changes to the serverconf.yaml configuration do not necessitate a restart of the dependent deployments. They simply fetch the updated configuration during their next runtime cycle, ensuring the use of the most recent, compatible settings. On the other hand, accounts.yaml could be mounted directly as part of the deployment. This setup implies that changes to accounts.yaml would require a restart of the dependent deployments, as the updated settings must be re-integrated with the existing deployment for them to take effect. If the configuration type is not required, there may be no need for a restart, leading the process to block 504.

At block 514, the process may determine whether version 2 additions for the internal system are in the deployment dependency. These additions could comprise newly added parameters, functions, APIs, or any other modifications that enhance the internal workings of the system, but do not necessarily have a direct influence on the external behaviors or dependencies of the deployment. They could be system optimizations, additions of internal tools, changes to the internal data structures, or alterations in the management of internal system resources. If this condition is satisfied, the system at block 504 determines that a restart should not be initiated, presuming that these additions do not directly impact the functioning of the dependent deployments.

At block 516, if none of the conditions described in the preceding blocks are satisfied, the process may determine that a restart should be initiated. It is to be understood that steps may be skipped, modified, or repeated in the illustrative embodiment. Moreover, the order of the blocks shown is not intended to require the blocks to be performed in the order shown, or any particular order.

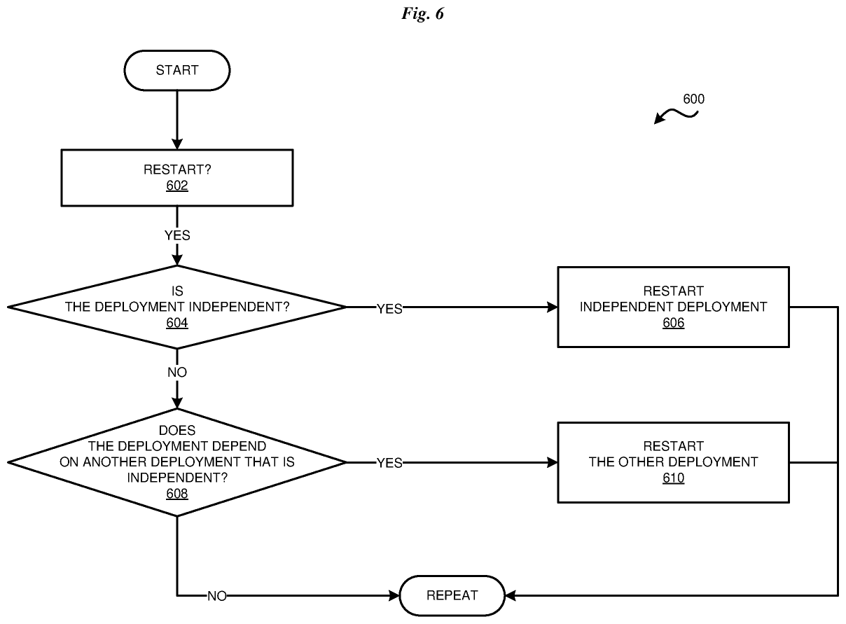

With reference to FIG. 6, this figure depicts a block diagram of an example process for restarting a deployment based on a deployment dependency in accordance with an illustrative embodiment 600. The example block diagram of FIG. 6 may be implemented using deployment restart engine 200 of FIG. 1.

In the illustrative embodiment, at block 602, the process may determine whether a restart should be initiated. This determination could be based on the same or similar evaluation from FIG. 5, which may check for breaking changes, whether version 2 retains all the necessary parts of version 1, whether it removes any non-essential components, and other similar factors. If a restart is indeed necessary based on these criteria, the process may proceed to the next step.

At block 604, the process may determine whether the deployment is independent, or whether it relies on another deployment. This step may involve an evaluation to ascertain whether the deployment marked for a potential restart is reliant on another deployment, such as trough a dependency graph or tree. A deployment may be considered independent if, when activated, the process determines that the deployment does not have any dependencies. The process may verify this condition by cross-referencing the deployment configurations, dependency maps, system metadata, or any other data. The dependency relationship between deployments might be due to shared resources, synchronized operations, data reliance, or API interactions.

The restart process for an independent deployment may be relatively straightforward, because there may be no other deployments that could be potentially impacted by the changes it undergoes during its restart. The process might also utilize this opportunity to implement any pending changes or updates for the independent deployment as it is less likely to disrupt other system operations.

If no such a dependency relationship is discovered, the mechanism may navigate to block 606, where the process may restart the independent deployment. This feature may be helpful in scenarios where a change in the dependent deployment can result in unexpected behaviors in the original deployment after its restart. To illustrate, suppose deployment A relies on data provided by deployment B. If a configuration change in deployment B modifies the data format, restarting deployment A before B could lead to operational issues or failures in A due to the unexpected data format.

In contrast, at block 608, if the deployment depends on another deployment, the process may determine whether the other deployment is independent. This step may involve checking if the other deployment (e.g., deployment B from the previous example) has dependencies of its own. This step may identify chains or cascades of dependencies, which might need to be addressed sequentially to maintain the system's stability during the restart process.

If the other deployment is independent, at block 610, the process may restart the other deployment. However, if the other deployment depends on yet another deployment, the process may repeat the above process until it locates an independent deployment, which it may restart once identified. For example, if deployment A is dependent on deployment B, and deployment B, in turn, depends on deployment C which is independent, the process may sequence the restarts as C->B->A to maintain the operational integrity of each deployment during the transition. This approach may help prevent potential disruptions or conflicts due to unaddressed dependencies.

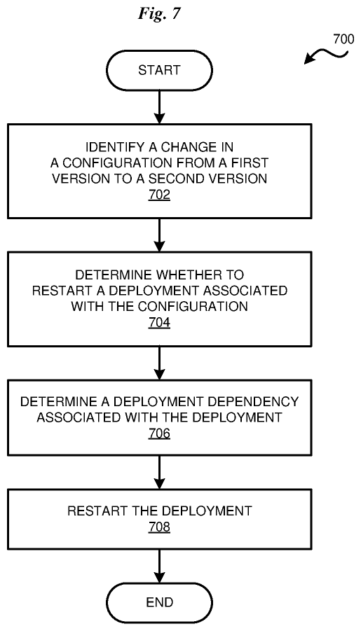

With reference to FIG. 7, this figure depicts a block diagram of an example process for adaptive deployment restart for configuration updates in accordance with an illustrative embodiment 700. The example block diagram of FIG. 7 may be implemented using deployment restart engine 200 of FIG. 1.

In the illustrative embodiment, at block 702, the process may identify a change in a configuration from a first version to a second version. At block 704, the process may determine, based on the change, whether to restart a deployment associated with the configuration. At block 706, the process may determine a deployment dependency associated with the deployment. At block 708, the process may restart, responsive to a determination to restart the deployment, based on the deployment dependency, the deployment. It is to be understood that steps may be skipped, modified, or repeated in the illustrative embodiment. Moreover, the order of the blocks shown is not intended to require the blocks to be performed in the order shown, or any particular order.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially.” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
identifying, by a deployment restart engine, a change in a configuration from a first version to a second version;
determining, by the deployment restart engine, based on the change, whether to restart a deployment associated with the configuration;
determining, by the deployment restart engine, a deployment dependency associated with the deployment; and
restarting, by the deployment restart engine, responsive to a determination to restart the deployment, based on the deployment dependency, the deployment.

2. The method of claim 1, wherein determining whether to restart the deployment based on the change further comprises at least one of:
determining whether the change is a breaking change that disrupts existing functionality of the deployment;
determining whether the second version contains the first version;
determining whether a deleted portion of the first version affects the deployment dependency;
determining whether the deployment dependency is scaled to zero;
determining whether a configuration type of the configuration is required by the deployment dependency; and
determining whether an addition of the second version is related to an external system.

3. The method of claim 1, wherein determining a deployment dependency further comprises:
determining whether the deployment depends on a second deployment.

4. The method of claim 3, wherein restarting the deployment based on the deployment dependency further comprises:
restarting the deployment responsive to a determination that the deployment does not depend on the second deployment.

5. The method of claim 3, wherein restarting the deployment based on the deployment dependency further comprises:
determining a second deployment dependency associated with the second deployment responsive to a determination that the deployment depends on the second deployment; and
restarting the second deployment based on the second deployment dependency.

6. The method of claim 1, further comprising:
determining a plurality of deployment dependencies associated with the configuration; and
determining, responsive to a determination to restart the deployment, a restart order for the plurality of deployment dependencies.

7. The method of claim 6, wherein the restart order begins with an independent deployment dependency.

8. The method of claim 1, further comprising:
selecting a restart technique responsive to a determination to restart the deployment.

9. The method of claim 8, wherein the restart technique includes at least one of a rolling restart and a blue-green restart.

10. A computer program product comprising one or more computer readable storage media, and program instructions collectively stored on the one or more computer readable storage media, the program instructions executable by a processor to cause the processor to perform operations comprising:
identifying, by a deployment restart engine, a change in a configuration from a first version to a second version;
determining, by the deployment restart engine, based on the change, whether to restart a deployment associated with the configuration;
determining, by the deployment restart engine, a deployment dependency associated with the deployment; and
restarting, by the deployment restart engine, responsive to a determination to restart the deployment, based on the deployment dependency, the deployment.

11. The computer program product of claim 10, wherein determining whether to restart the deployment based on the change further comprises at least one of:
determining whether the change is a breaking change that disrupts existing functionality of the deployment
determining whether the second version contains the first version
determining whether a deleted portion of the first version affects the deployment dependency
determining whether the deployment dependency is scaled to zero
determining whether a configuration type of the configuration is required by the deployment dependency; and
determining whether an addition of the second version is related to an external system.

12. The computer program product of claim 10, wherein determining a deployment dependency further comprises:
determining whether the deployment depends on a second deployment.

13. The computer program product of claim 12, wherein restarting the deployment based on the deployment dependency further comprises:
restarting the deployment responsive to a determination that the deployment does not depend on the second deployment.

14. The computer program product of claim 12, wherein restarting the deployment based on the deployment dependency further comprises:
determining a second deployment dependency associated with the second deployment responsive to a determination that the deployment depends on the second deployment; and
restarting the second deployment based on the second deployment dependency.

15. The computer program product of claim 10, further comprising:
selecting a restart technique responsive to a determination to restart the deployment.

16. A computer system comprising a processor and one or more computer readable storage media, and program instructions collectively stored on the one or more computer readable storage media, the program instructions executable by the processor to cause the processor to perform operations comprising:
identifying, by a deployment restart engine, a change in a configuration from a first version to a second version;
determining, by the deployment restart engine, based on the change, whether to restart a deployment associated with the configuration;
determining, by the deployment restart engine, a deployment dependency associated with the deployment; and
restarting, by the deployment restart engine, responsive to a determination to restart the deployment, based on the deployment dependency, the deployment.

17. The computer system of claim 16, wherein determining whether to restart the deployment based on the change further comprises at least one of:
determining whether the change is a breaking change that disrupts existing functionality of the deployment
determining whether the second version contains the first version
determining whether a deleted portion of the first version affects the deployment dependency
determining whether the deployment dependency is scaled to zero
determining whether a configuration type of the configuration is required by the deployment dependency; and
determining whether an addition of the second version is related to an external system.

18. The computer system of claim 16, wherein determining a deployment dependency further comprises:
determining whether the deployment depends on a second deployment.

19. The computer system of claim 16, further comprising:
determining a plurality of deployment dependencies associated with the configuration; and
determining, responsive to a determination to restart the deployment, a restart order for the plurality of deployment dependencies.

20. The computer system of claim 16, further comprising:
selecting a restart technique responsive to a determination to restart the deployment.
